(19) United States
(12) Patent Application Publication
(10) Pub. No.: US 2006/0067204 A1
(43) Pub. Date: Mar. 30, 2006

(54) Objective lens and scanning device using such an objective lens

(75) Inventors: Bernardus Hendrikus Wilhelmus Hendriks, Eindhoven (NL); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,840

(22) PCT Filed: Nov. 24, 2003
(86) PCT No.: PCT/IB03/05376

§ 371 Date: May 31, 2005

(30) Foreign Application Priority Data
Dec. 4, 2002 (EP) 022929962

(51) Int. Cl. G11B 15/64; G11B 17/32

(52) U.S. Cl. 369/300

(57) ABSTRACT

The invention relates to an objective lens and an optical device for scanning different information carriers having different cover layer thicknesses, with different numerical apertures. The objective lens (10, 20) comprises at least an annular part (101, 201) having a first numerical aperture and a central part (102, 203) having a second numerical aperture. The second numerical aperture is higher than the first numerical aperture.

### FIELD OF THE INVENTION

The present invention relates to an objective lens for scanning information carriers having transparent layers with different thicknesses.

The present invention also relates to a scanning device for scanning information carriers having transparent layers with different thicknesses.

The present invention is particularly relevant for an optical disc apparatus for reading and/or recording data from and/or to different optical discs, e.g. a CD/DVD/BD player and/or recorder.

### BACKGROUND OF THE INVENTION

In the field of optical recording, increasing the capacity of the information carrier is the trend. The capacity of an information layer depends, inter alia, on the size of the spot formed by a radiation beam focused on the information layer. The higher the numerical aperture of the radiation beam, the smaller the spot size. As a consequence, different types of information carriers have been developed or are under development in order to increase the capacity of the information carrier. For example, a CD (Compact Disc) has been developed which has a capacity of 700 megabytes and which is scanned by a radiation beam having a numerical aperture (NA) of 0.45. A DVD (Digital Video Disc) has then been developed which has a capacity of 4.7 gigabytes and which is scanned by a radiation beam having a NA of 0.65. Right now, a BD (Blu-Ray Disc) is being developed which has a capacity of about 25 gigabytes and which is scanned by a radiation beam having a NA of 0.85.

Furthermore, when the NA is increased, it is necessary to reduce the thickness of the transparent layer protecting the information layer, so as to reduce the influence of disc tilt on the quality of the radiation beam. For example, the thickness of the transparent layer of a CD is 1.2 millimeters, the thickness of the transparent layer of a CD is 0.6 millimeters and the thickness of the transparent layer of a BD is 0.1 millimeters.

A compatible player and/or recorder should be able to scan the different types of information carrier. U.S. Pat. No. 6,052,237 describes a scanning device capable of scanning two different types of information carriers having different thicknesses of their transparent layer. This scanning device comprises a radiation source and an objective lens having an outer annular part and a central part inside the annular part. The annular part has a numerical aperture higher than the numerical aperture of the central part.

This scanning device is capable of scanning a first information carrier having a first transparent layer with a first thickness and a second information carrier having a second transparent layer with a second thickness greater than the first thickness. The annular part introduces a first spherical aberration into the radiation beam compensating for the passage of the radiation beam through the first transparent layer, and the central part introduces a second spherical aberration into the radiation beam compensating for the passage of the radiation beam through the second transparent layer.

When the second information carrier is scanned, the radiation beam passes through the central part and the second transparent layer and is focused on a second information layer. When the first information carrier is scanned, the radiation beam passes through the combined area of the annular part and the central part and through the first transparent layer and is focused on a first information layer.

In this scanning device, the spherical aberration introduced by the first transparent layer is compensated, because the correction of the central part of the objective lens for a thickness of the transparent layer different from the thickness of the transparent layer for which the annular part is corrected has only a relatively small influence.

This may be true when the NA of the annular part is 0.6 and the NA of the central part is 0.33, as stated in this patent. However, it is not true anymore when the NA of the annular part is increased, for example, to 0.85. As a consequence, such a scanning device cannot be used for scanning, for example, a Blu-Ray Disc and a DVD. Actually, in order to use such an objective lens for scanning a BD and a DVD, the annular part should have a NA of 0.85. In order to reduce the influence of the central part on the radiation beam having a NA of 0.85, the central part should be as small as possible. Unfortunately, a small central part cannot be used, because the free working distance of the central part would be too small to cope with the thickness of the transparent layer of a DVD.

### SUMMARY OF THE INVENTION

It is an object of the invention to provide an objective lens and a scanning device for scanning different types of information carriers with increased numerical apertures.

To this end, the invention proposes an objective lens comprising at least an annular part having a first numerical aperture and a central part having a second numerical aperture, wherein the second numerical aperture is higher than the first numerical aperture.

At least a first information carrier having a first transparent layer with a first thickness and a second information carrier having a second transparent layer with a second thickness greater than the first thickness can be scanned by a scanning device comprising an objective lens in accordance with the invention. When scanning the first information carrier, a first radiation beam is focused on a first information layer by means of the central part of the objective lens. The first NA may be taken as high as desired, as a function of the information carriers intended to be scanned by the scanning device. For example, the first NA may be 0.85, in order to scan a BD Disc. When scanning the second information carrier, a second radiation beam is focused on a second information layer by means of the combined areas of the annular part and the central part of the objective lens. Only the part of the radiation beam passing through the annular part of the objective lens is focused on the second information layer. However, when scanning the second information layer with the second numerical aperture, the central part of the second radiation beam may be dispensed with without affecting the quality of the scanning, because the second numerical aperture is relatively low compared with the first numerical aperture. For example, the second numerical aperture is 0.65.

If, as in the prior art, the first numerical aperture is lower than the second numerical aperture, the quality of the scanning would be affected when scanning an information layer with a relatively high NA through the combined area of the annular part and the central part of the objective lens. Actually, a radiation beam having a high NA, such as 0.85, is very sensitive, and the absence of the central part of such a beam leads to a relatively bad scanning.

Advantageously, the objective lens comprises an optical axis and a cavity located around said optical axis, said cavity having a substantially cylindrical shape, the bottom of said cavity forming the central part of the objective lens.

Such an objective lens is particularly advantageous, as it can be relatively small. Actually, if a radius of the annular part is relatively small, the radius of the central part is even smaller. As a consequence, the free working distance of the central part is small and can be smaller than the width of the objective lens in the direction of its optical axis. However, in such an objective lens having a cavity, the central part of the objective lens can be placed near the output surface of the objective lens. As a consequence, an information carrier with a relatively small thickness of the transparent layer can be scanned, even if the free working distance of the central part is small.

Furthermore, such an objective lens is relatively easy to manufacture, as it can be moulded. A mould might be manufactured that has a profile suitable for producing the objective lens when an optical material, such as glass or plastic, is introduced in the mould. Hence, a large quantity of objective lenses can be manufactured with a high accuracy by means of the same mould.

The invention also relates to a lens assembly comprising a first lens with an annular part having a first numerical aperture and a central part, and a second lens, the second lens and the central part of the first lens forming a dual-element objective lens having a second numerical aperture, wherein the second numerical aperture is higher than the first numerical aperture.

Such a lens assembly advantageously replaces the objective lens as described hereinbefore. Instead of the central part of the objective lens, a dual-element objective lens is used. This is particularly advantageous when the lens assembly is made from plastic, which has a low refractive index. Actually, in the objective lens as described hereinbefore, the curvature of the central part is high when the NA of the central part is high. This requires a relatively high accuracy during the manufacturing process, which is not required when a dual-element objective lens is used.

The invention also relates to an optical scanning device for scanning at least a first type of information carrier having a first information layer and a first transparent layer of a first thickness and a second type of information carrier having a second information layer and a second transparent layer of a second thickness greater than the first thickness, said optical scanning device comprising means for generating at least a first and a second radiation beam and an objective lens comprising at least an annular part having a first numerical aperture and a central part having a second numerical aperture higher than the first numerical aperture, wherein the first information layer is intended to be scanned by the first radiation beam through the central part of the objective lens and the first transparent layer and the second information layer is intended to be scanned by the second radiation beam through the annular part of the objective lens and the second transparent layer.

The invention also relates to an optical scanning device for scanning at least a first type of information carrier having a first information layer and a first transparent layer of a first thickness and a second type of information carrier having a second information layer and a second transparent layer of a second thickness greater than the first thickness, said optical scanning device comprising means for generating at least a first and a second radiation beam and a lens assembly comprising a first lens with an annular part having a first numerical aperture and a central part, and a second lens, the second lens and the central part of the first lens forming a dual-element objective lens having a second numerical aperture higher than the first numerical aperture, wherein the first information layer is intended to be scanned by the first radiation beam through the dual-element objective lens and the first transparent layer, and the second information layer is intended to be scanned by the second radiation beam through the annular part of the first lens and the second transparent layer.

These and other aspects of the invention will be apparent from and will be elucidated with reference to the embodiments described hereinafter.

### BRIEF DESCRIPTION OF THE DRAWINGS

The invention will now be described in more detail, by way of example, with reference to the accompanying drawings, in which:

FIGS. 1a and 1b show an objective lens in accordance with the invention;

FIG. 2 shows another objective lens in accordance with the invention;

FIGS. 3a and 3b show a lens assembly in accordance with the invention; and

FIG. 4 shows a scanning device in accordance with the invention.

### DETAILED DESCRIPTION OF THE INVENTION

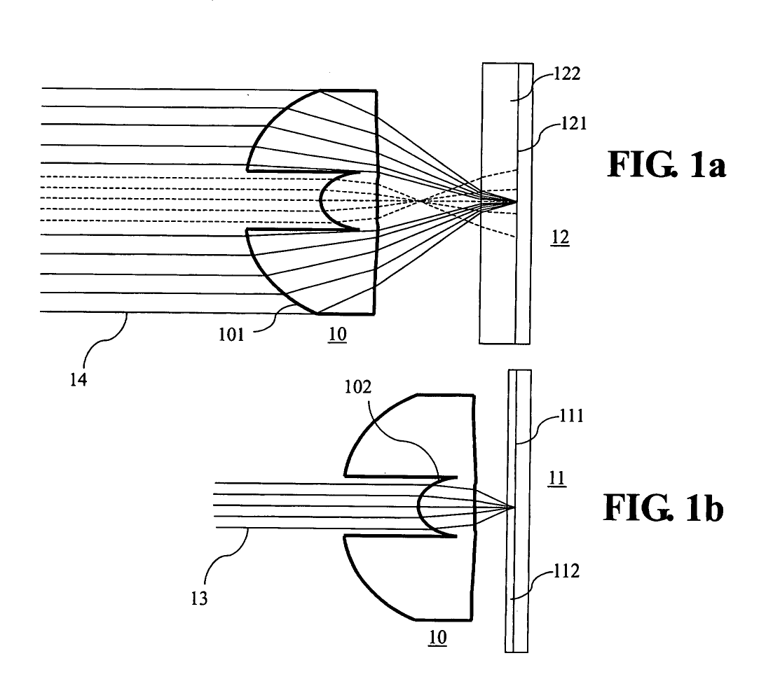

An objective lens in accordance with the invention is depicted in FIGS. 1a and 1b. Such an objective lens 10 comprises an annular part 101 and a central part 102. In FIG. 1b, the objective lens 10 is used for scanning a first information carrier 11 comprising an information layer 111 and a transparent layer 112. In FIG. 1a, the objective lens 10 is used for scanning a second information carrier 12 comprising an information layer 121 and a transparent layer 122.

In the example to be described below, the first information carrier 11 is a BD scanned by a first radiation beam 13 and the second information carrier 12 is a DVD scanned by a second radiation beam 14. The first radiation beam 13 has a first wavelength of 405 nanometres. The second radiation beam 14 has a second wavelength of 650 nanometres. The thickness of the first transparent layer 112 is 0.1 millimetres and the thickness of the second transparent layer 122 is 0.6 millimetres. The radius of the annular part 101 is 1.8 millimetres and the radius of the central part 102 is 0.5 millimetres. The NA of the annular part 101 is 0.65 and the NA of the central part 102 is 0.85. The focal length of the annular part 101 is 2.75 millimetres and the focal length of the central part 102 is 0.58 millimetres.

When the first information layer 111 is scanned, the first radiation beam 13, which is a parallel beam having a diameter substantially equal to the diameter of the central part 102, passes through the central part 102 and is focused on the first information layer 11 1, through the first transparent layer 112. The objective lens 10 can be moved along its optical axis in order to obtain an accurate focus. As the central part has a relatively small radius and a relatively high NA, the free working distance of the central part 102, which represents the maximum possible distance between the output surface of the central part 102 and the surface of the transparent layer 112, is relatively small. In this example, the free working distance of the central part 102 is about 0.4 millimetres. However, according to the invention, this is not a problem, because the central part 102 of the objective lens 10 is used for scanning information carriers having transparent layer of a small thickness. As a consequence, the NA of the central part 102 can be high, for example higher than 0.7 or even higher than 0.8.

When the second information layer 121 is scanned, the second radiation beam 14, which is a parallel beam having a diameter substantially equal to the diameter of the annular part 101, passes through the combined areas of the annular part 101 and the central part 102. Compared with the scanning of the first information layer 111, the objective lens 10 is moved along its optical axis in a direction opposed to the first information layer 111 when a second information layer is scanned. This is possible, because the free working distance of the annular part 101 of the objective lens 10 is relatively great, as the radius of the annular part 101 is great and the NA of the annular part 101 is low. The NA of the annular part 101 is preferably between 0.35 and 0.7, but may be higher if the NA of the central part 102 is even higher. For example, the NA of the central part 102 may be higher than 0.9, 1, 1.1 or 1.2. In these cases, the NA of the annular part 101 may be 0.7, 0.8, 0.9 or 1, respectively, for example. Preferably, the NA of the annular part 101 is more than ten percent lower than the NA of the central part 102.

When the second information layer 121 is scanned, the outer portion of the second radiation beam 14, corresponding to the portion of the second radiation beam 14 passing through the annular part 101, is focused on the second information layer 121. The central portion of the second radiation beam 14, corresponding to the portion of the second radiation beam 14 passing through the central part 102, is not focused on the second information layer 121. As a consequence, this central portion of the second radiation beam 14 is not used for scanning the second information layer 121. However, this does not affect the scanning, because the NA of the second radiation beam 14 is relatively small, so that the signal read or written to or from the second information layer 121 is not affected by the absence of a central portion of the second radiation beam 14.

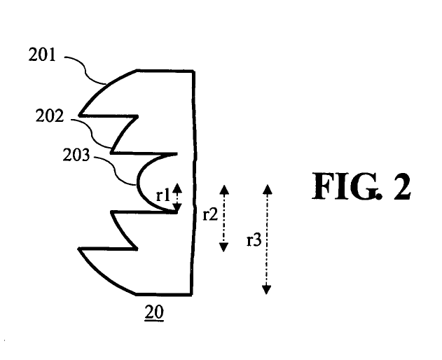

It is important to note that the objective lens of FIGS. 1a and 1b can be used for scanning more than two different types of information carriers. For example, this objective lens may be used for scanning a CD. In order to scan a CD, the annular part 101 of the objective lens 10 is divided into a first annular area having a NA equal to 0.45 and a second annular area having a NA equal to 0.6. The first annular area is located near the optical axis of the objective lens 10. Such an annular part 101 may be used for scanning a CD and a DVD, as explained in U.S. Pat. No. 6,052,237, which does not apply to an annular part divided into two annular areas, but to a lens divided into two areas. As a consequence, such an objective lens can be used for scanning a CD, a DVD or a BD. Another objective lens according to the invention, which may be used for scanning a CD, a DVD or a BD, is depicted in FIG. 2.

FIG. 2 shows another objective lens in accordance with the invention. Such an objective lens 20 comprises a first annular part 201, a second annular part 202, and a central part 203.

The radius r3 of the first annular part 201 is 1.8 millimetres, the radius r2 of the second annular part 202 is 1.2 millimetres, and the radius r1 of the central part 203 is 0.5 millimetre. The NA of the first annular part 201 is 0.45, the NA of the second annular part 202 is 0.65, and the NA of the central part 203 is 0.85.

When a CD is scanned by means of the objective lens 20, a third radiation beam having a wavelength of 785 nanometres and a radius substantially equal to r3 passes through the combined areas of the first annular part 201, the second annular part 202 and the central part 203. Only the portion of the third radiation beam passing through the first annular area 201 is focused on an information layer of the CD. However, this does not affect the scanning, as explained hereinbefore, because the NA of the third radiation beam is low.

When a DVD is scanned by means of the objective lens 20, a second radiation beam having a wavelength of 650 nanometres and a radius substantially equal to r2 passes through the combined areas of the second annular part 202 and the central part 203. As explained with reference to FIGS. 1a and 1b, the scanning is not affected by the fact that only the portion of the second radiation beam passing through the second annular part 202 is used for the scanning.

When a BD is scanned by means of the objective lens 20, a first radiation beam having a wavelength of 405 nanometres and a radius substantially equal to r1 passes through the central part 203 and is focused on an information layer of the BD.

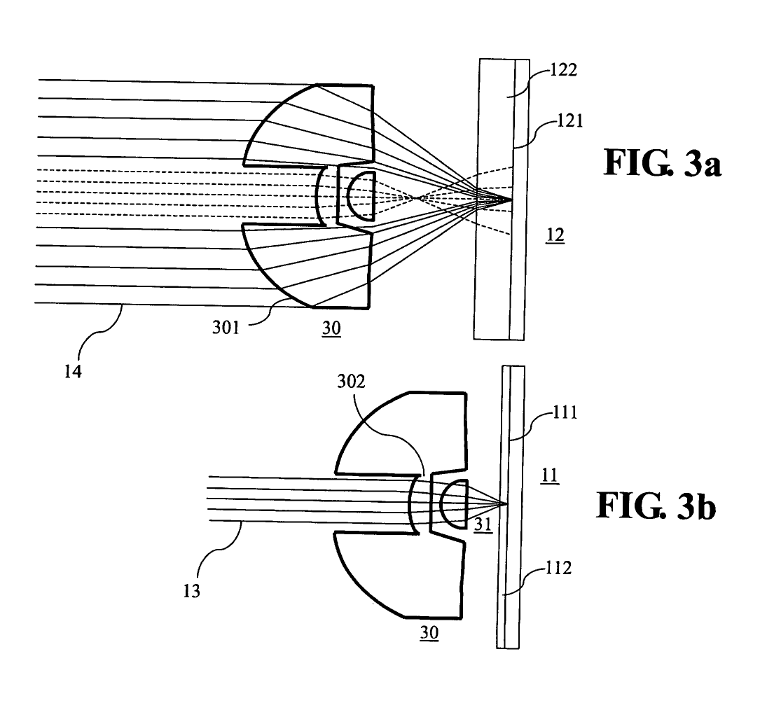

FIGS. 3a and 3b show a lens assembly in accordance with the invention. Such a lens assembly comprises a first lens 30 comprising an annular part 301 and a central part 302, and a second lens 31. The central part 302 of the first lens 30 and the second lens 31 are combined in order to form a dual-element objective lens. This dual-element objective lens has a numerical aperture of to 0.85. The annular part 301 of the first lens 30 has a numerical aperture of 0.65.

When the first information layer 111 is scanned, the first radiation beam 13 passes through the dual-element objective lens and is focused on the first information layer 111, through the first transparent layer 112. When the second information layer 121 is scanned, the second radiation beam 14 passes through the combined areas of the annular part 301 and the dual-element objective lens.

As explained in the description of FIGS. 1a and 1b, the lens assembly of FIGS. 3a and 3b may be used for scanning more than two different types of information carrier.

Compared with the objective lens of FIGS. 1a and 1b, the lens assembly is easier to manufacture. Actually, manufacturing a single-element objective lens having a high NA requires a high accuracy during the manufacturing process, which is not the case with a dual-element objective lens, because the curvatures of the two elements can be lower than the curvature of a single element.

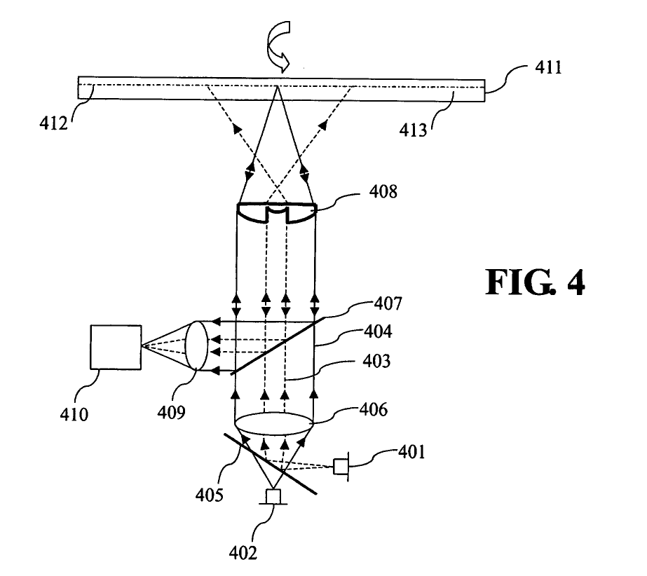

FIG. 4 shows a scanning device in accordance with the invention. Such an optical scanning device comprises a first radiation source 401 for producing a first radiation beam 403, a second radiation source 402 for producing a second radiation beam 404, a first beam splitter 405, a collimator lens 406, a second beam splitter 407, an objective lens 408, a servo lens 409, and detecting means 410. This optical device is intended for scanning an information carrier 411 comprising an information layer 412 and a transparent layer 413.

In the example depicted in FIG. 4, the information carrier 411 is a DVD. The information layer 412 is scanned by the second radiation beam 404 produced by the second radiation source 402. The second radiation beam 404 has a second wavelength equal to 650 nanometres. The collimator lens 406 and the objective lens 408 focus the second radiation beam 404 on the information layer 412 through the transparent layer 413 having a thickness of 0.6 millimetre. The objective lens 408 is the objective lens 10 of FIGS. 1a and 1b. Instead of the objective lens 10 of FIGS. 1a and 1b, the lens assembly of FIG. 3a and 3b may be used as the objective lens 408.

When a different information layer is to be scanned, such as a BD disc, this information layer is scanned by the first radiation beam 403 produced by the first radiation source 401. The first radiation beam 403 has a first wavelength equal to 405 nanometres. In order to achieve the scanning of a BD disc, the objective lens is moved in the direction of the information carrier 411 by means of an actuator not shown in FIG. 4. The scanning device is designed such that the diameter of the second radiation beam 404 is substantially equal to the diameter of the annular part of the objective lens 408, and the diameter of the first radiation beam 403 is substantially equal to the diameter of the central part of the objective lens 408.

The second radiation beam 404, reflected by the information layer 412, is transformed into a parallel beam by the objective lens 408, and then reaches the servo lens 409, via the second beam splitter 407. This reflected beam then reaches the detecting means 410, which, for example, are capable of detecting a focus error signal. This also applies to the first radiation beam 403, when a BD disc is scanned.

It is important to note that the scanning device of FIG. 4 may be used for scanning more than two different types of information carriers. For example, a third radiation source may be provided in the optical scanning device, said third source being able to produce a third radiation beam having a third wavelength equal to 785 nanometres. This third radiation beam may be used for scanning a CD. In this case, the objective lens 20 of FIG. 2 may be used as the objective lens 408.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical scanning device for scanning at least a first type of information carrier (11) having a first information layer (111) and a first transparent layer (112) of a first thickness and a second type of information carrier (12, 411) having a second information layer (121, 412) and a second transparent layer (122, 413) of a second thickness greater than the first thickness, said optical scanning device comprising means (401, 402) for generating at least a first and a second radiation beam (403, 404), and an objective lens (10, 20, 408) comprising at least an annular part (101, 201) having a first numerical aperture and a central part (102, 203) having a second numerical aperture higher than the first numerical aperture, wherein the first information layer is intended to be scanned by the first radiation beam through the central part of the objective lens and the first transparent layer, and the second information layer is intended to be scanned by the second radiation beam through the annular part of the objective lens and the second transparent layer.

2. An optical scanning device as claimed in claim 1, wherein said objective lens comprises an optical axis and a cavity located around said optical axis, said cavity having a substantially cylindrical shape, the bottom of said cavity forming the central part of the objective lens.

3. An optical scanning device as claimed in claim 1, wherein the second numerical aperture is higher than 0.7 and the first numerical aperture is more than ten per cent lower than the first numerical aperture.

4. An optical scanning device for scanning at least a first type of information carrier having a first information layer and a first transparent layer of a first thickness and a second type of information carrier having a second information layer and a second transparent layer of a second thickness greater than the first thickness, said optical scanning device comprising means for generating at least a first and a second radiation beam, and a lens assembly comprising a first lens (30) with an annular part (301) having a first numerical aperture and a central part (302), and a second lens (31), the second lens and the central part of the first lens forming a dual-element objective lens having a second numerical aperture higher than the first numerical aperture, wherein the first information layer is intended to be scanned by the first radiation beam through the dual-element objective lens and the first transparent layer, and the second information layer is intended to be scanned by the second radiation beam through the annular part of the first lens and the second transparent layer.

5. An objective lens (10, 20) comprising at least an annular part (101, 201) having a first numerical aperture and a central part (102, 203) having a second numerical aperture, wherein the second numerical aperture is higher than the first numerical aperture.

6. An objective lens as claimed in claim 5, said lens comprising an optical axis and a cavity located around said optical axis, said cavity having a substantially cylindrical shape, the bottom of said cavity forming the central part of the objective lens.

7. An objective lens as claimed in claim 5, wherein the second numerical aperture is higher than 0.7 and the first numerical aperture is more than ten per cent lower than the first numerical aperture.

8. An objective lens as claimed in claim 5, wherein the first numerical aperture is between 0.35 and 0.7 and the second numerical aperture is higher than 0.7.

9. An objective lens as claimed in claim 5, wherein the first numerical aperture is between 0.35 and 0.7 and the second numerical aperture is higher than 0.8.

10. A lens assembly comprising a first lens (30) with an annular part (301) having a first numerical aperture and a central part (302), and a second lens (31), the second lens and the central part of the first lens forming a dual-element objective lens having a second numerical aperture, wherein the second numerical aperture is higher than the first numerical aperture.
